(19) United States
(12) Patent Application Publication
(10) Pub. No.: US 2023/0419169 A1
(43) Pub. Date: Dec. 28, 2023

(54) ADVERSARIAL CORRUPTION FOR ATTRIBUTION-BASED EXPLANATIONS VALIDATION

(71) Applicant: Oracle International Corporation, Redwood Shores, CA (US)

(72) Inventors: Kenyu Kobayashi, Lausanne (CH); Arno Schneuwly, Effretikon (CH); Renata Khasanova, Zurich (CH); Matteo Casserini, Zurich (CH); Felix Schmidt, Baden-Dattwil (CH)

(21) Appl. No.: 17/851,120

(22) Filed: Jun. 28, 2022

(51) Int. Cl. G06N 20/00

(52) U.S. Cl. CPC G06N 20/00

(57) ABSTRACT

Herein are machine learning (ML) explainability (MLX) techniques that perturb a non-anomalous tuple to generate an anomalous tuple as adversarial input to any explainer that is based on feature attribution. In an embodiment, a computer generates, from a non-anomalous tuple, an anomalous tuple that contains a perturbed value of a perturbed feature. In the anomalous tuple, the perturbed value of the perturbed feature is modified to cause a change in reconstruction error for the anomalous tuple. The change in reconstruction error includes a decrease in reconstruction error of the perturbed feature and/or an increase in a sum of reconstruction error of all features that are not the perturbed feature. After modifying the perturbed value, an attribution-based explainer automatically generates an explanation that identifies an identified feature as a cause of the anomalous tuple being anomalous. Whether the identified feature of the explanation is or is not the perturbed feature is detected.

### FIELD OF THE INVENTION

The present invention relates to machine learning (ML) explainability (MLX). Herein are techniques that perturb a non-anomalous tuple to generate an anomalous tuple as adversarial input to any explainer that is based on feature attribution.

### BACKGROUND

Machine learning (ML) and deep learning are becoming ubiquitous for two main reasons: their ability to solve complex problems in a variety of different domains and growth in performance and efficiency of modern computing resources. However, as the complexity of problems continues to increase, so too does the complexity of the ML models applied to these problems.

Deep learning is a prime example of this trend. Other ML algorithms, such as typical neural networks, may only contain a few layers of densely connected neurons, whereas deep learning algorithms, such as convolutional neural networks, may contain tens to hundreds of layers of neurons performing very different operations. Increasing the depth of the neural model and heterogeneity of layers provides many benefits. For example, providing more depth can increase the capacity of the model, improve the generalization of the model, and provide opportunities for the model to filter out unimportant features, while including layers that perform different operations can greatly improve the performance of the model. However, these optimizations come at the cost of increased complexity and reduced human interpretability of model operation.

Explaining and interpreting the results from complex deep learning models is a challenging task compared to many other ML models. For example, a decision tree may perform binary classification based on N input features. During training, the features that have the largest impact on the class predictions are inserted near the root of the tree, while the features that have less impact on class predictions fall near the leaves of the tree. Feature importance can be directly determined by measuring the distance of a decision node to the root of the decision tree.

Such models are often referred to as being inherently interpretable. However, as the complexity of the model increases (e.g., the number of features or the depth of the decision tree increases), it becomes increasingly challenging to interpret an explanation for a model inference. Similarly, even relatively simple neural networks with a few layers can be challenging to interpret, as multiple layers combine the effects of features and increase the number of operations between the model inputs and outputs. Consequently, there is a requirement for advanced techniques to aid with the interpretation of complex ML and deep learning models.

Some MLX evaluation methods do not work with opaque (i.e. black-box) ML models whose internal architecture is hidden or too complex, such as an artificial neural network (ANN). Some MLX evaluation methods only work with interpretable ML models whose internal architecture directly reflects the ML model's behavior, such as a decision tree.

MLX has recently gotten increasing attention because understanding why an ML model makes a certain prediction can be as crucial as the prediction's accuracy in many applications. Feature attribution-based explanation (ABX) methods are often used to explain the rationale behind an ML model's decision-making process. ABX methods may operate by indicating how much each feature that was input into an ML model contributed to the predictions for each given instance.

In the field of anomaly detection, one prominently used ML model architecture of deep neural networks (DNNs) is the autoencoder. Autoencoder architecture is mainly designed to transcode the input data into a compressed (e.g. dimensionality reduction), meaningful representation, and decode it back to the original size such that a reconstruction of the input is as similar as possible to the original input. Each feature in a tuple such as a feature vector may have a reconstruction error per the following feature formula, where i is a current feature, x is an input tuple, and X is a reconstruction of the input.

(xᵢ−\hat{x}ᵢ)²

As a reconstructive model, the objective of an autoencoder is to minimize a reconstruction error, r(x) that may be defined by the following error formula, where m is a count of features.

$$\frac{1}{m} {\sum }_{i = 1}^{m} {( {x}_{i} - {\hat{x}}_{i} )}^{2}$$

By training to minimize the above error formula on a large data collection, an autoencoder learns an informative representation of the data in lower dimensionality (encoding step) such that the reconstruction into the original size (decoding step) has a small error. An autoencoder is often used to solve an anomaly detection problem. Because anomalous tuples are not correctly reconstructed from the lower dimensionality representation, an indicator of interest for anomaly detection is the reconstruction error per the above error formula. A tuple is considered anomalous if a trained autoencoder has significantly large reconstruction error for the tuple.

Perturbation (a.k.a. corruption) is a way to synthesize an anomalous tuple as an imperfect copy of a non-anomalous tuple, which may be based on a corruption function that provides a perturbation value for a perturbed feature. A characteristic of some existing corruption functions is that the anomalous tuples they generate are limited to one specific class of anomalies. The resulting anomalous tuples are identified with a corrupted feature that has a large share of reconstruction error per the above error formula. Validating attribution based explanation (ABX) methods with such tuples entails assessing the capability of assigning high attributions to features having a large respective reconstruction error per the above feature formula. In other words, detecting the corrupted feature is mostly feasible by looking at a single indicator, which is the feature reconstruction error.

### BRIEF DESCRIPTION OF THE DRAWINGS

In the drawings:

FIG. 1 is a block diagram that depicts an example computer that perturbs a non-anomalous tuple to generate an anomalous tuple as adversarial input to any explainer that uses feature attribution to generate an explanation;

FIG. 2 is a flow diagram that depicts an example computer process that perturbs a non-anomalous tuple to generate an anomalous tuple as adversarial input to any explainer that uses feature attribution to generate an explanation;

FIG. 3 is a flow diagram that depicts an example computer process that iteratively perturbs a non-anomalous tuple to generate an anomalous tuple as adversarial input to any explainer that uses feature attribution to generate explanation;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Herein are machine learning (ML) explainability (MLX) techniques that perturb a non-anomalous tuple to generate an anomalous tuple as adversarial input to any explainer that is based on feature attribution. This is an empirical evaluation approach to assess the performance of attribution-based explanation (ABX) methods applied to an anomaly detector that is a reconstructive ML model.

For a given tuple such as a feature vector, the anomaly detector may infer an anomaly score inclusively ranging between zero and one. To determine whether a tuple is anomalous, anomaly score threshold T is used. A tuple with an anomaly score greater than T is anomalous.

An early step of this approach artificially introduces an anomaly into a tuple by corrupting one feature by applying a corruption function. After many anomalous tuples are synthesized, another step of this approach entails evaluating an ABX method's capability to identify the corrupted features when explaining the anomalies.

When evaluating ABX methods used to explain a reconstructive anomaly detector, existing corruption functions have a serious limitation. In practice, some existing corruption functions generate only a specific kind of anomalies. For ABX methods, validation approaches that rely on those existing corruption functions only measure the capability to explain anomalies limited to that kind, which leads to an incomplete performance assessment of ABX methods.

The evaluation of explainability techniques is a fundamental challenge in the field of MLX. ABX methods tend to emphasize detecting a feature for which the reconstruction error is relatively large. In practice, there is another kind of anomalies that originate from features that have a small reconstruction error, while causing the reconstruction errors from other features to be large. In this case, other ABX methods relying on the feature reconstruction errors would fail to generate an accurate explanation. Existing corruption functions fail to generate tuples of this other kind of anomalies.

Herein is a corruption function that introduces an anomaly to a tuple, such that a corrupted feature's share of reconstruction error is counterintuitively small. The corruption of the selected feature causes an increase of respective reconstruction errors of all features except the corrupted feature itself. Various ABX explainers would perform poorly because the corrupted feature would receive a relatively small attribution. This confusion of ABX explainers causes inaccurate explanations that have inverted attributions. Experiments show that random and null corruption virtually never leads to such inverted attributions. With such corruption, ABX explainers are never fully tested, and fully comparing the performance of different ABX explainers is impossible.

In an embodiment, a computer generates, from a non-anomalous tuple, an anomalous tuple that contains a perturbed value of a perturbed feature. In the anomalous tuple, the perturbed value of the perturbed feature is modified to cause a change in reconstruction error for the anomalous tuple. The change in reconstruction error includes a decrease in reconstruction error of the perturbed feature and/or an increase in a sum of reconstruction error of all features that are not the perturbed feature. After modifying the perturbed value, an ABX explainer automatically generates an explanation that identifies an identified feature as a cause of the anomalous tuple being anomalous. Whether the identified feature of the explanation is or is not the perturbed feature is detected.

### 1.0 Example Computer

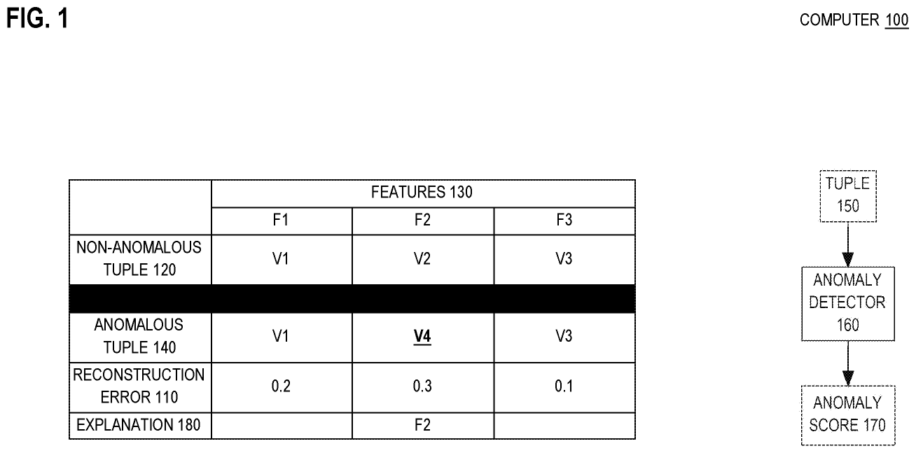

FIG. 1 is a block diagram that depicts an example computer 100, in an embodiment. For machine learning (ML) explainability (MLX), computer 100 perturbs non-anomalous tuple 120 to generate anomalous tuple 140 as adversarial input to any explainer that uses feature attribution to generate explanation 180. Computer 100 may be one or more of a rack server such as a blade, a personal computer, a mainframe, a virtual computer, or other computing device.

### 1.1 Anomaly Detector

Computer 100 hosts in memory and operates anomaly detector 160 that may or may not have an unknown, opaque (i.e. black box), or confusing architecture that more or less precludes direct inspection and interpretation of the internal operation of anomaly detector 160. Anomaly detector 160 is a machine learning (ML) model that is already trained. In an embodiment, anomaly detector 160 is an artificial neural network (ANN) such as a deep neural network (DNN).

Functionally, anomaly detector 160 is a numeric regression that generates or infers a numeric anomaly score that measures how unfamiliar, abnormal, or suspicious is a tuple such as any of tuples 120, 140, and 150. In various embodiments, the anomaly score is or is not a probability that a tuple is anomalous. A numeric anomaly score may be compared to a predefined anomaly threshold to detect whether or not the tuple is anomalous. Generally, an anomalous tuple should have a higher anomaly score than a non-anomalous tuple.

### 1.2 Machine Learning Explainability (MLX)

As discussed later herein and although not shown, an explainer is a software component hosted by computer 100 to generate a respective explanation of why anomaly detector 160 generated the anomaly score of any given tuple. For example in various scenarios, a tuple, its anomaly score, and/or anomaly detector 160 are reviewed for various reasons. ML explainability (MLX) herein can provide combinations of any of the following functionalities:
Explainability: The ability to explain why a given anomaly score occurred for a tuple.
Interpretability: The level at which a human can understand the explanation.
What-If Explanations: Understand how changes in a tuple may or may not change the anomaly score and/or change the tuple from anomalous to non-anomalous or vice versa.
Model-Agnostic Explanations: Explanations may treat anomaly detector 160 as a black box, instead of using internal properties from anomaly detector 160 to guide the explanation.

For example, the explanation may be needed for regulatory compliance. Likewise, the explanation may reveal an edge case that causes anomaly detector 160 to malfunction for which retraining with different data or a different hyperparameters configuration is needed.

### 1.3 Feature Engineering

Each of tuples 120, 140, and 150 contains a respective value for each of features F1-F3. For example as shown, the value of feature F1 in tuples 120 and 140 is value VI. Tuple 150 is shown with a dashed outline to demonstrate that tuple 150 may be any individual tuple of tuples 120 or 140.

Tuple 150 contains a respective value for each of features 130. In an embodiment, tuple 150 is, or is used to generate, a feature vector that anomaly detector 160 accepts and that contains more or less densely encoded respective values for features 130. Each of features 130 has a respective datatype. For example, features F1 and F3 may or may not have a same datatype. A datatype may variously be: a) a number that is an integer or real, b) a primitive type such as a Boolean or text character that can be readily encoded as a number, c) a sequence of discrete values such as text literals that have a semantic ordering such as months that can be readily encoded into respective numbers that preserve the original ordering, or d) a category that enumerates distinct categorical values that are semantically unordered.

Categories are prone to discontinuities that may or may not seemingly destabilize anomaly detector 160 such that different categorical values for a same feature may or may not cause anomaly detector 160 to generate very different anomaly scores. One categorical feature may be hash encoded into one number in a feature vector or n-hot or 1-hot encoded into multiple numbers. For example, 1-hot encoding generates a one for a categorical value that actually occurs in a tuple and also generates a zero for each possible categorical value that did not occur in the tuple.

Tuple 150 may represent various objects in various embodiments. For example, tuple 150 may be or represent a network packet, a record such as a database table row, or a log entry such as a line of text in a console output logfile. Likewise, features 130 may be respective data fields, attributes, or columns that can occur in each object instance.

Anomaly detector 160 may be applied to a tuple such as tuple 150 to generate anomaly score 170 that is shown with a dashed outline to demonstrate that anomaly score 170 may be any individual anomaly score of a given tuple of tuples 120 and 140. Anomaly score 170 indicates whether or not tuple 150 is anomalous such as based on a threshold. When anomaly detector 160 detects an anomaly in a production environment, an alert may be generated to provoke a human or automated security reaction such as terminating a session or network connection, rejecting tuple 150 from further processing, and/or recording, diverting, and/or alerting tuple 150 for more intensive manual or automatic inspection and analysis.

### 1.4 Reconstructive Model

Anomaly detector 160 is a reconstructive ML model. A reconstructive model more or less accurately regenerates its input tuple. In an embodiment, anomaly detector 160 is an autoencoder.

In an embodiment, an autoencoder may be a multilayer perceptron (MLP) such as a deep neural network (DNN). Functionally, classification entails associating an inferred label with a complex input. In other words, classification entails recognizing a learned pattern. Anomaly detection does the opposite, which is recognizing that tuple 150 does not match any learned pattern.

Generally during training, an autoencoder learns which features should be deemphasized and how to encode retained semantic features. An autoencoder herein further is a reconstructive model because the autoencoder contains additional neural layers that are trained to regenerate the original input. In other words, the autoencoder encodes tuple 150 into a semantic coding, which the autoencoder further decodes back into a more or less accurate copy of tuple 150.

An autoencoder may have various neural layers or subsets of layers that perform learned activity of a dedicated nature as follows. An input layer may be specialized for encoding input features 130. An output layer may be specialized for generating anomaly score 170.

Layers such as a hidden layer or an activation layer may be specialized for semantic analysis as needed for learned fitness of indirectly connecting input layers to output layers.

In an embodiment, anomaly detector 160 instead is a principal component analysis (PCA). Although operationally very different from an autoencoder, PCA is a reconstructive model that is functionally similar to an autoencoder as follows. Like an autoencoder, PCA undergoes unsupervised training to learn dimensionality reduction and minimize reconstruction error. Architectures of PCA and autoencoders are discussed later herein.

### 1.5 Reconstruction Error

A measured difference between the original input and the regenerated input is referred to as reconstruction error. Because the original input and the regenerated input are composed of individual features F1-F3, a difference may be measured between an original value of a feature and a reconstructed value of the feature to calculate a respective reconstruction error for that feature. A respective reconstruction error may be measured for each of features F1-F3 as shown in reconstruction error 110 for anomalous tuple 140.

Integration such as by summation, mean, or maximum of respective reconstruction errors of all features 130 may be used to calculate a loss that measures how much relevant information did anomaly detector 160 lose when inferencing for tuple 150. As discussed below, loss may indicate reconstruction error that occurs in a regenerated input as compared to the original input. Loss is informally or mathematically the opposite of inference accuracy. That is, the higher is loss, the less reliably did anomaly detector 160 recognize tuple 150. For anomaly detection, high loss, such as exceeding a threshold, may indicate that tuple 150 is anomalous.

### 1.6 Anomaly Detection

As discussed above, anomaly detection entails recognizing that a complex input matches no learned pattern. In other words, anomaly detection entails recognizing unfamiliarity, which has the following implications.

Accurate input reconstruction is eventually achieved during training. Without training, accurate reconstruction is impossible, in which case reconstruction error is high. By definition, an unfamiliar input is any tuple that anomaly detector 160 was not trained for. Thus an unfamiliar input in a production environment necessarily causes a high reconstruction error.

In a production environment, an unfamiliar input is an anomaly, which is detectable due to its high reconstruction error. Thus, anomaly detector 160 detects an anomaly when a reconstruction error exceeds an anomaly threshold.

### 1.7 Explainers

An explainer (not shown) may be applied to anomalous tuple 140 to generate explanation 180 that indicates one or more of features 130 as a cause of anomaly score 170 of anomalous tuple 140 being anomalous.

One or more values respectively for one or more of features 130 may cause anomalous tuple 140 to be anomalous. In this example, a respective one of features 130 actually causes anomalous tuple 140 to be anomalous. For example, value V4 is shown as bold and underlined to indicate that feature F2 actually caused anomalous tuple 140 to be anomalous. Actual causality is discussed later herein.

Explanation 180 may be more or less inaccurate. For example although not shown, the explainer may generate an explanation that wrongly indicates that feature F1 is why anomalous tuple 140 is anomalous. As shown, the explainer instead generates explanation 180 that correctly indicates that F2 is the reason that anomalous tuple 140 is anomalous.

### 1.8 Explanation Assessment

Which of features 130 actually cause anomaly detector 160 to generate anomaly score 170 high enough for arbitrary tuple 150 to be anomalous may be difficult or impossible to directly observe because anomaly detector 160 may be opaque. As follows, computer 100 may specially select and modify tuple 150 in a controlled way that provides exact knowledge of which of features 130 is a cause of an anomaly. With such knowledge, computer 100 may reliably classify individual explanations as correct or incorrect.

In an embodiment, non-anomalous tuple 120 is (e.g. randomly) selected from a corpus that contains non-anomalous tuples and some or no anomalous tuples. In an embodiment, tuples in the corpus are unlabeled such that which tuples are non-anomalous is initially unknown. Anomaly detector 160 may generate a respective anomaly score for tuple 150 selected from the corpus and, based on anomaly score 170 and an anomaly threshold, tuple 150 may be selected as verified non-anomalous tuple 120. Anomalous tuples in the corpus are unused herein.

### 1.9 Perturbation

From non-anomalous tuple 120, a perturbed tuple is generated as anomalous tuple 140. Herein, a perturbed tuple is an imperfect copy of a non-anomalous tuple. For example, anomalous tuple 140 is an imperfect copy of non-anomalous tuple 120. A perturbed tuple is generated by modifying the value of a feature of a non-anomalous tuple. Perturbed value V4 for perturbed feature F2 is shown in bold and underlined in anomalous tuple 140. Whereas, value V3 of feature F3 is exactly copied into anomalous tuple 140 from non-anomalous tuple 120.

Anomalous tuple 140 is special because: a) it can be readily verified as anomalous by anomaly detector 160, and b) which feature(s) caused anomalous tuple 140 to become anomalous by perturbation is known. For example, value V4 of feature F2 is known to be a cause of anomalous tuple 140 being anomalous, which can be used to detect the accuracy of explanation 180 for anomalous tuple 140. For example, computer 100 may automatically detect that explanation 180 correctly identifies feature F2 as a cause of anomalous tuple 140 being anomalous. Likewise, computer 100 may automatically detect an incorrect explanation for an anomalous tuple that was generated by perturbing a non-anomalous tuple.

Explanation 180 is an attribute-based explanation (ABX). To generate explanation 180, the explainer may analyze the three reconstruction errors of respective features F1-F3 as shown in reconstruction error 110 for anomalous tuple 140. Either expressly or effectively/coincidentally, the explainer may identify a feature with the highest respective reconstruction error as the cause of anomalous tuple 140 being anomalous. For example as shown, the respective reconstruction error of feature F2 is higher than the reconstruction errors of features F1 and F3. As presented later herein, intelligent and iterative perturbation of feature F2, without perturbing other features F1 and F3, and even though anomalous tuple 140 remains anomalous, may cause: a) the respective reconstruction error of feature F2 to be the lowest, or at least not the highest, and/or b) the respective reconstruction error of feature F1 and/or F3 to be higher than that of feature F2. In other words, that special perturbation may cause anomalous tuple 140 to become adversarial to the explainer, which increases the likelihood that explanation 180 will instead incorrectly identify a feature, such as feature F1 or F3, that is not the cause of anomalous tuple 140 being anomalous. Thus as discussed later herein, adversarial perturbation may stress test an explainer, which may empirically reveal the suitability/fitness of the explainer.

In an embodiment, an explainer implements Shapley additive explanation (SHAP) as presented in non-patent literature (NPL) “A unified approach to interpreting model predictions” published by Scott Lundberg et al in Advances In Neural Information Processing Systems 30 (2017) that is incorporated in its entirety herein.

In an embodiment, an explainer implements local interpretable model-agnostic explanations (LIME) as presented in NPL “Why should I trust you? Explaining the predictions of any classifier” published by Marco Ribeiro et al in Proceedings of the 22nd ACM SIGKDD International Conference on Knowledge Discovery and Data Mining (2016) that is incorporated in its entirety herein. In an embodiment, an explainer combines SHAP and LIME (e.g. kernel SHAP as presented in the SHAP NPL).

In an embodiment, anomaly detector 160 is an artificial neural network (ANN) that is not opaque, and computer 100 has full access to the weights of the connections between neurons in the ANN such as for backpropagation as discussed later herein. An explainer may implement an explanation approach that is based on backpropagation such as layer-wise relevance propagation (LRP) as presented in NPL “On pixel-wise explanations for non-linear classifier decisions by layer-wise relevance propagation” published by Sebastian Bach et al in Public Library of Science (PLOS) One, volume 10 number 7 (2015) that is incorporated in its entirety herein. Due to the integration with internals of an ANN, the approach herein is accelerated when LRP is used.

In an embodiment not shown, any or both of anomaly detector 160 and the explainer are active components hosted in a different computer that is not computer 100, and computer 100 applies techniques herein by remotely using the active component. For example, computer 100 may send tuple 150 to an active component over a communication network and responsively receive anomaly score 170 or an explanation over the communication network. For example, computer 100 and the active component may be owned by different parties and/or hosted in different data centers. In various embodiments that host the active component in computer 100, techniques herein may or may not share an address space and/or operating system process with the active component. For example, inter-process communication (IPC) may or may not be needed to invoke the active component.

### 2.0 Example Perturbation Process

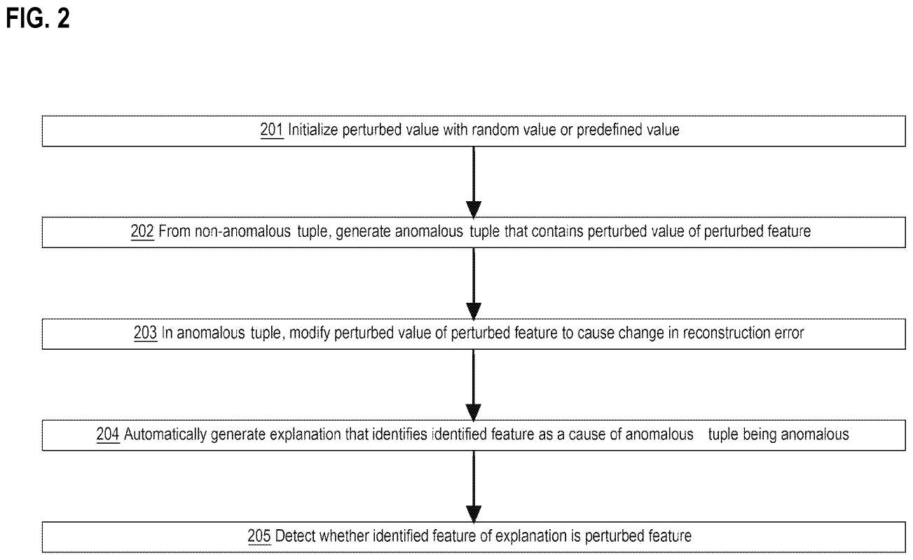

FIG. 2 is a flow diagram that depicts an example process that an embodiment of computer 100 may perform to perturb non-anomalous tuple 120 to generate anomalous tuple 140 as adversarial input to any explainer that uses feature attribution to generate explanation 180. FIG. 2 is discussed with reference to FIG. 1.

In various embodiments, step 201 initializes a perturbed value with a random value or a predefined value such as zero or null. Depending on the embodiment, step 201 uses an initial value that may or may not: a) be in the value range of a feature to be perturbed, b) be independent of the feature to be perturbed, and c) cause an anomaly.

From non-anomalous tuple 120, step 202 generates anomalous tuple 140 that contains the perturbed value of the perturbed feature. For example in anomalous tuple 140, step 202 may set perturbed feature F2 to perturbed value V4.

In an embodiment, steps 201-202 are not implemented, and the process of FIG. 2 instead begins with step 203. In an embodiment, steps 201-202 are repeated until anomaly detector 160 infers an anomaly score 170 that indicates that perturbed tuple 140 is anomalous. In various embodiments, repetition of steps 201-202 entails: a) reusing same non-anomalous tuple 120 or b) (e.g. randomly) selecting (e.g. with or without replacement) another non-anomalous tuple 120 from a corpus.

In anomalous tuple 140, step 203 modifies perturbed value V4 of perturbed feature F2 to cause a change in anomaly detector 160's reconstruction error for anomalous tuple 140. Step 203 may be repeated for same anomalous tuple 140 according to repetition heuristics discussed later herein. For example if perturbed tuple 140 becomes non-anomalous, then repetition should revisit any or all of steps 201-203. Step 204 should not occur with a perturbed tuple 140 that is non-anomalous.

Step 204 automatically generates explanation 180 that correctly or incorrectly identifies an identified feature as a cause of anomalous tuple 140 being anomalous. During steps 202-204, tuples 120 and 140 are identical except for their respective values of perturbed feature F2. For example during steps 202-204, tuples 120 and 140 have a same first value for feature F1 and a same second value for feature F3.

Step 205 detects whether or not the identified feature of explanation 180 is the perturbed feature. In an embodiment, explanation 180 identifies a small subset of features 130 as causal, and step 205 detects whether or not the identified subset contains the perturbed feature. In an embodiment, explanation 180 ranks features 130 by (e.g. decreasing) causality, and step 205 detects whether or not a threshold count of top ranked features contains the perturbed feature.

### 3.0 Example Iterative Perturbation Process

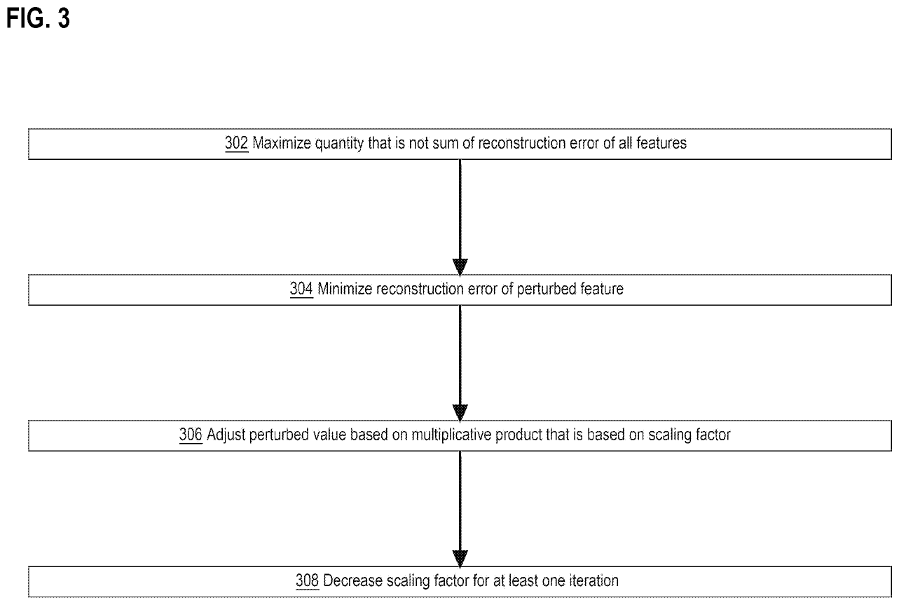

FIG. 3 is a flow diagram that depicts an example process that an embodiment of computer 100 may perform to iteratively perturb non-anomalous tuple 120 to generate anomalous tuple 140 as adversarial input to any explainer that uses feature attribution to generate explanation 180. FIG. 3 is discussed with reference to FIG. 1. The steps of FIGS. 2-3 are complementary and may be interleaved or combined.

As discussed earlier herein, an explainer may expressly or effectively/coincidentally identify a feature with a highest respective reconstruction error as a cause of anomalous tuple 140 being anomalous. In order to stress test an explainer as discussed earlier herein, an adversarially perturbed tuple should have features with high respective reconstruction errors that are not the perturbed feature, which may confuse the explainer.

Step 302 maximizes a quantity that is not a sum of respective reconstruction errors of all features 130 for anomalous tuple 140. That is, the quantity that step 302 maximizes is not the sum of numbers in all columns in reconstruction error 110. For example, step 302 may maximize a sum of respective reconstruction errors of a subset of features 130, such as all features 130 except perturbed feature F2.

In order to stress test an explainer as discussed earlier herein, an adversarially perturbed tuple should have low respective reconstruction error for the perturbed feature, which may confuse the explainer. Step 304 minimizes the respective reconstruction error of perturbed feature F2 for anomalous tuple 140.

Steps 302 and 304 have different respective objectives that may or may not be antagonistic to each other. Thus, a practical implementation of the process of FIG. 3 may or may not balance the objectives of steps 302 and 304 in a way that does not maximally satisfy the objectives of steps 302 and 304. For example as discussed below, the result of such balance may be a modification of the perturbed value of perturbed feature F2 that provides neither a maximum for step 302 nor a minimum for step 304.

In an embodiment, an optimum balance is provided by maximizing the following loss formula.

$$( {\sum }_{i = 1 ; i \neq c}^{m} e ( x , i ) ) - w * e ( x , c )$$

The following terms have the following meanings in the above loss formula.
m is how many features (e.g. three) are in features 130.
c is the one-based index (e.g. two) of perturbed feature F2 in array of features 130.
i is the one-based index of each unperturbed feature (e.g. F1 and F3) in array of features 130.
x is anomalous tuple 140.
e( ) is the feature formula in the above Background, which is the respective reconstruction error of a given feature for perturbed tuple 140, which is a component of reconstruction error 110.
w is a predefined positive weight that may be (e.g. an order of magnitude) greater than one.

The above loss formula does not measure reconstruction error 110 as provided by anomaly detector 160. The above loss formula is based on already measured reconstruction error 110. The above loss formula is an adversarial metric that measures how confusing anomalous tuple 140 is likely to be for an explainer that uses attribution based explanation (ABX) to generate explanation 180. Herein, the goal is to maximize the likelihood of confusing the explainer by maximizing the above loss formula, such as in the following way.

As discussed earlier herein, modification of the perturbed value of perturbed feature F2 may iteratively occur such that each iteration makes a small modification to the previous iteration's value of perturbed feature F2. Because a modification to one feature may change the respective reconstruction errors of multiple (e.g. all) features, each iteration may calculate a respective gradient of the respective reconstruction errors of all features 130 based on the small modification to the perturbed value of perturbed feature F2 of the current iteration. Those respective gradients may provide feedback for greedy hill-climbing iterations such as gradient descent in a way that pursues the objectives of steps 302 and 304. In other words, steps 302 and 304 may be combined and implemented as greedy iterations.

To incrementally/iteratively optimize the above loss formula in an embodiment, step 306 adds a dynamic signed increment to the current value of perturbed feature F2 between a previous iteration and a next iteration. In an embodiment, the dynamic signed increment is calculated with the following increment formula that step 306 may implement.

sign(∇ₓ_{_{c}}r(x_{N},c))α

The following terms have the following meanings in the above increment formula.
N is the previous iteration.
x_{N} is anomalous tuple 140 in the previous iteration.
c is perturbed feature F2.
r( ) is the above loss formula, which is not the above increment formula.
x_{c} is the value of perturbed feature F2 in anomalous tuple 140 in the previous iteration.
∇ₓ_{_{c}} is the gradient of loss formula r( ) for the perturbed feature F2.
sign( ) is −1, 0, or +1 respectively for negative, zero, and positive values, which does not depend on the magnitude of the value.
a is a (e.g. dynamic) scaling factor as a step size of the increment; a should be positive and (e.g. much) less than one.

In other words, the above loss formula may be embedded in the above increment formula. In an embodiment, the above increment formula invokes the above loss formula. Between iterations, the increment calculated by the above increment formula is either −α, zero, or +α, depending on the current result of the sign( ) expression.

The result of the sign( ) expression may be the same or different for any two iterations. Thus, whether the value of perturbed feature F2 is increasing or decreasing depends on the iteration, and the direction (i.e. increasing or decreasing) may change multiple times while iterating.

Due to iterative gradient descent, the final value of perturbed feature F2 after iteration ceases may be any value in a natural range of feature F2. The final value of perturbed feature F2 is not limited in any way by the value of feature F2 in non-anomalous tuple 120 nor by the initial perturbed value of feature F2 when iteration starts.

Between iterations, step 306 adjusts the value of perturbed feature F2 by adding an increment that is based on a multiplicative product that is based on a scaling factor. In an embodiment, the scaling factor is a, and the multiplicative product is a times the current result of the sign( ) expression as shown in the above increment formula.

Step 308 decreases the scaling factor (e.g. α) for at least one iteration. Decreasing the scaling factor also decreases the magnitude of the increments that the above increment formula generates. In an embodiment, the scaling factor is decreased in some iterations and unchanged in other iterations. In an embodiment, the scaling factor monotonically decreases, even if unchanged in some iterations. In an embodiment, whether or not to decrease the scaling factor is a dynamic (i.e. adaptive) decision in each iteration.

In an embodiment, step 308 geometrically decreases the scaling factor, even if unchanged in some iterations. For example, a next scaling factor may be half of a previous scaling factor.

In an embodiment, iteration ceases after a predefined count of iterations. In an embodiment, the process of FIG. 2 or 3 is repeated a predefined count of times to generate that predefined count of anomalous tuples 140 from (e.g. that predefined count of) non-anomalous tuples 120.

In an embodiment, the process of FIG. 3 is repeated with another (e.g. randomly selected) non-anomalous tuple 120 until an anomalous tuple 140 occurs when iterating ceases that is sufficiently adversarial according to at least one of the following enumerated stopping criteria:
the reconstruction error of perturbed feature F2 is less than each respective reconstruction error of other features F1 and F3 that are not the perturbed feature,
the reconstruction error of perturbed feature F2 is less than at least one respective reconstruction error of other features F1 and F3 that are not the perturbed feature, and
the reconstruction error of perturbed feature F2 is less than an average respective reconstruction error of: all features 130 or all features that are not the perturbed feature.

In an embodiment, the above enumerated stopping criteria may cause the process of FIG. 3 to cease after any iteration, and not necessarily only after a predefined count of iterations.

### 4.0 Exemplary Embodiment

Here is an exemplary embodiment of computer 100 that generates a hundred anomalous tuples 140 by adversarial perturbation techniques presented earlier herein. Details of the exemplary embodiment are not necessarily limitations of embodiments presented earlier herein.

Each anomalous tuple 140 has a respective perturbed feature that is randomly selected with replacement from features 130. Each anomalous tuple 140 is an imperfect copy of a respective non-anomalous tuple 120 that is randomly selected with replacement from a corpus of tuples that represent respective entries in operational log(s) such as console output logs of an application.

Features 130 contains twenty-two features. Anomaly detector 160 is an autoencoder as presented elsewhere herein. The process of FIG. 3 has three thousand iterations per anomalous tuple 140. Anomaly score 170 has an inclusive range of zero to one. The anomaly score threshold is 0.3. The following terms have the following predefined values.
α initially is 0.001 in the above increment formula.
w is ten in the above loss formula.

Decreasing scaling factor α is conditioned on at least one, at least two, or all of the following:
a predefined count of ten iterations occurs since previously decreasing the scaling factor;
the respective reconstruction error of the perturbed feature is not less than the respective reconstruction error of the perturbed feature was when previously decreasing the scaling factor; and
a sum of respective reconstruction errors of all features that are not the perturbed feature is not less than a sum of respective reconstruction errors of all features that are not the perturbed feature when previously decreasing the scaling factor.

The processes of FIGS. 2-3 are combined into a combined process that is repeated for each of the hundred anomalous tuples 140 and for each of three different explainers (i.e. 100*3=300 times, which is not the same as the above iterations in each of those times) to select a best explainer that generates the most correct explanations 180 or to rank the explainers by respective count of correct explanations 180.

Various implementations of the exemplary embodiment may or may not adversarially achieve one or both of the following exemplary extreme confusions of explainer(s) for one explanation 180 or as an average of many explanations 180 (e.g. each with a respective perturbed feature):
Explanation(s) allocate a (e.g. average) fraction of attribution to a feature that is not the perturbed feature, and that fraction is more than: fifty percent, seventy percent, or eighty percent; and
Explanation(s) allocate a (e.g. average) fraction of attribution to the perturbed feature, and that fraction is less than: twenty percent, ten percent, and five percent.

### 5.0 Example Pseudocode

An embodiment of computer 100 may or may not implement the following example pseudocode listing 1.

Listing 1: Adversarial Corruption Algorithm for Autoencoders

```
Input: model: the Autoencoder Model
  init_dp: the datapoint to be corrupted using adversarial
  optimization
  c_idx: the index of the feature to be corrupted (or that
  has already been corrupted using the random corruption)
  n_steps: the total number of updates
  α: the step size
  k: the numbers of updates before testing if α should be
  halved
  w: the weight to be assigned to the reconstruction of the
  corrupted feature
Output: corr_dp: the anomalous datapoint generated through
Adversarial Corruption
1 Function apply adversarial corruption(model, init_dp, c_idx,
n_steps, α, k, w):
2 /* Applies the Adversarial Corruption to an initial datapoint
*/
3
4 // Initial corrupted feature and its reconstruction
5 init_c = init_dp[c_idx]
6 init_c_reconstruct = model.forward pass(init_dp)[c_idx]
7
8 // Initial corrupted feature's reconstruction error
9 init_c_reconstruct_err = mse(init_c, init_c_reconstruct)
10
11 // Initial reconstruction of the vector without the corrupted
feature
12 init_vect_reconstruct = model.forward pass(init_dp)
13 init_not_c_reconstruct = init_vect_reconstruct.remove element
at index(c_idx)
14
15 // Initial reconstruction error of the vector withtout the
corrupted feature
16 init_not_c = init_dp.remove element at index(c_idx)
17 init_not_c_reconstruct_err = mse(init_not_c,
init_not_c_reconstruct)
18
19 // Initialization
20 last_corr_c_reconstruct_err = init_c_reconstruct_err
21 last_corr_not_c_reconstruct_err = init_not_c_reconstruct_err
22 corr_dp = init_dp.copy( )
23
24 // Perform n optimization_steps
25 for i in range(n_steps) do
  26
  27 // Compute adversarial gradient
  28 gradient = compute_adversarial_gradient(model, corr_dp,
  c_idx, w)
  29
  30 // Update the corrupted feature such that it increases
  the custom loss
  31 corr_dp[c_idx] = corr_dp[c_idx] +
  α*sign(gradient[c_idx])
  32
  33 // Datapoint values clipping - to be used only if
  features are scaled between 0 and 1
  34 corr_dp = clip_by_value(corr_dp, clip value min = 0,
  clip value max = 1)
  35
  36 // Step Size Updater (every k steps)
  37 if i%k==0 then
    38
    39 // Corrupted feature reconstruction error
    40 corr_c = corr_dp[c_idx]
    41 corr_c_reconstruct = model.forward
    pass(corr_dp)[c_idx]
    42 corr_c_reconstruct_err = mse(corr_c,
    corr_c_reconstruct)
    43
    44 // Reconstruction error of the vector without the
    corrupted feature
    45 corr_not_c = corr_dp.remove element at index(c_idx)
    46 corr_vect_reconstruct = model.forward pass(corr_dp)
    47 corr_not_c_reconstruct =
    corr_vect_reconstruct.remove element at index(c_idx)
    48 corr_not_c_reconstruct_err = mse(corr_not_c,
    corr_not_c_reconstruct)
    49
    50 // Reduce the step size if the update didn't
    decrease corr_c_reconstruct_err & increase
    corr_not_c_reconstruct_err
    51 if last_corr_c_reconstruct_err <
    corr_c_reconstruct_err) and
    (last_corr_not_c_reconstruct_err >
    corr_not_c_reconstruct_err) then
    52 step_size = step_size/2
    53
    54 // Save the last reconstruction errors
    55 last_corr_c_reconstruct_err =
    corr_c_reconstruct_err
    56 last_corr_not_c_reconstruct_err =
    corr_not_c_reconstruct_err
    57
58 end for
59 return corr_dp
```

An embodiment of computer 100 may or may not implement the following example pseudocode listing 2 that provides helper subroutines that may be invoked in example pseudocode listing 1. In the pseudocode, a colon character in an array index expression has the same meaning as in the Python scripting language.

Listing 2: Helpers functions for the
Adversarial Corruption Algorithm

```
1 Function compute_adversarial_gradient(model, dp, c_idx, w):
  2 /* Computes the gradient for Adversarial Optimization */
  3
  4 // The sizes of the corrupted feature and the vector
  without the corrupted feature
  5 c_size = 1
  6 dp_without_c_size = dp.size − c_size
  7
  8 // Compute the weights to be assigned to the two parts of
  the loss
  9 loss_weights = array_ones(dp.size)
  10
  11 // The parts of the loss that encourages the corrupted
  feature's decrease in reconstruction loss
  12 loss_weights[c_idx] = −w * loss_weights[c_idx]
  13
  14 // The parts of the loss that encourages the
  reconstruction loss's increase
  15 loss_weights[:c_idx] = loss_weights[:c_idx] * (c_size /
  dp_without_c_size)
  16 loss_weights[c_idx:] = loss_weights[c_idx: ] * (c_size /
  dp_without_c_size)
  17
  18 // Compute the custom loss
  19 reconstructed_dp = model.forward pass(dp)
  20 loss = compute_r_adv(dp, reconstructed_dp, loss_weights)
  21
  22 // Get the gradient of the custom loss with respect to
  dp
  23 gradient = get_gradient(loss, dp)
  24 return gradient
  25
26 Function compute_r_adv(dp, reconstructed_dp, loss_weights):
  27 /* Computes the custom loss for Adversarial Optimization
  */
  28
  29 // Compute the element-wise reconstruction errors
  30 reconstruction_errors = square(dp, reconstructed_dp)
  31
  32 // Compute the custom loss
  33 custom_loss = multiply(reconstruction_errors,
  loss_weights)
  34 custom_loss = mean(custom_loss)
  35
  36 return custom_loss
  37
38 Function mse(v1, v2):
  39 /* Computes the mean squared error between two vectors
  v1 and v2 */
  40
  41 return mean(square(v1, v2));
  42
43 Function square (v):
  44 /* Returns the element-wise square of v - for example,
  square([1,2,3]) returns [1,4,9] */
  45
  46
47 Function multiply(v1, v2):
  48 /* Returns the element-wise multiplication of v1 by v2 -
  for example, multiply([1,2,3], [4,5,6])
  returns [1,10,18] */
  49
  50
51 Function mean(v):
  52 /* Returns the mean of v - for example, mean([1,2,3])
  returns 2 * /
  53
  54
55 Function sign(v):
  56 /* Returns the sign of v - for example, sign([−4,2,30])
  returns [−1,1,1] */
  57
  58
59 Function clip_by_value(v, clip value min, clip value max):
  60 /* Clips v between the upper and lower bounds - for
  example, clip_by_value([3,−4,0.5], 0, 1) returns
  [1,0,0.5] */
  61
  62
63 Function array_ones(size):
  64 /* Returns an array of ones of specified size - for
  example, array_ones(5) returns [1,1,1,1,1] */
  65
  66
67 Function get_gradient (f, x):
  68 /* Returns the gradient of f with respect to x */
  69
```

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

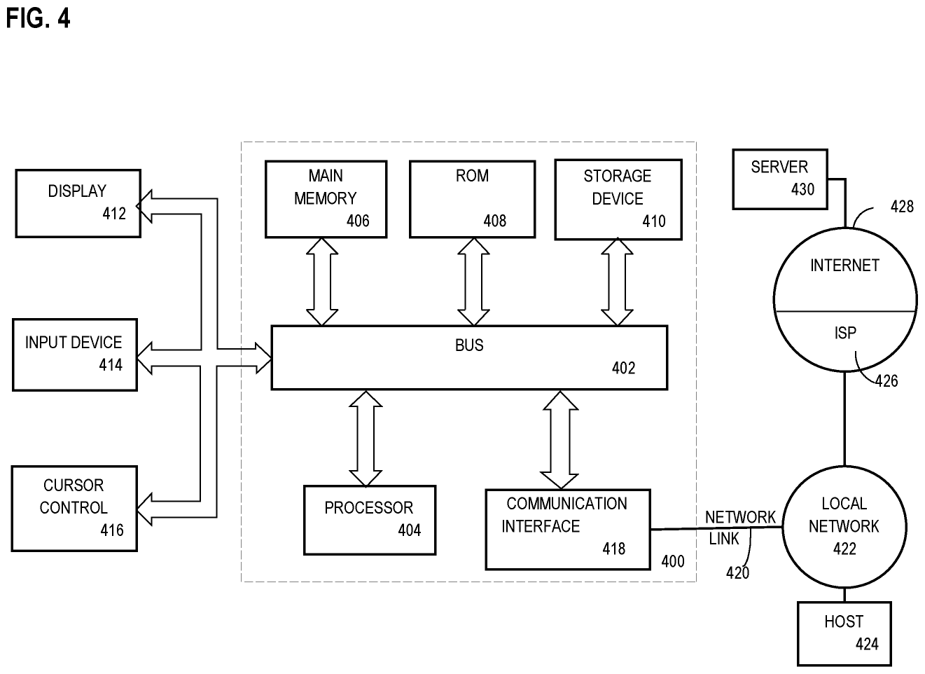

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

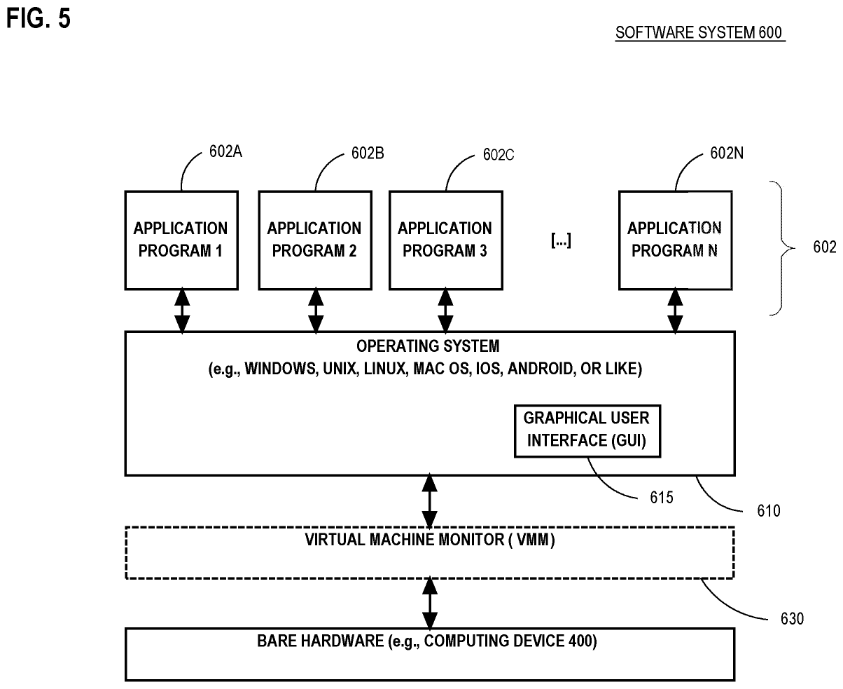

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as discussed above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating, from a non-anomalous tuple, an anomalous tuple that contains a perturbed value of a perturbed feature of a plurality of features;
modifying, in the anomalous tuple, the perturbed value of the perturbed feature to cause a change in reconstruction error for the anomalous tuple, wherein the change in reconstruction error comprises at least one selected from the group consisting of:
a decrease in reconstruction error of the perturbed feature, and
an increase in a sum of reconstruction error of the plurality of features that are not the perturbed feature;
automatically generating, after said modifying the perturbed value, an explanation that identifies an identified feature of the plurality of features as a cause of the anomalous tuple being anomalous;
detecting whether the identified feature of the explanation is the perturbed feature;
wherein the method is performed by one or more computers.

2. The method of claim 1 wherein said modifying the perturbed value is based on maximizing a quantity that is not a sum of reconstruction error of the plurality of features.

3. The method of claim 1 wherein said modifying the perturbed value is partly based on minimizing reconstruction error of the perturbed feature.

4. The method of claim 1 wherein:
said modifying the perturbed value is repeated in multiple iterations;
said modifying the perturbed value in an iteration comprises adjusting the perturbed value based on a multiplicative product that is based on a scaling factor;
the method further comprises decreasing the scaling factor for at least one iteration.

5. The method of claim 4 wherein the decreasing the scaling factor is geometric.

6. The method of claim 4 wherein said decreasing the scaling factor is conditioned on at least one selected from the group consisting of:
a predefined count of iterations occurs since previously decreasing the scaling factor;
the respective reconstruction error of the perturbed feature is not less than the respective reconstruction error of the perturbed feature was when previously decreasing the scaling factor; and
a sum of respective reconstruction errors of the plurality of features that are not the perturbed feature is not less than a sum of respective reconstruction errors of the plurality of features that are not the perturbed feature when previously decreasing the scaling factor.

7. The method of claim 4 wherein the multiplicative product is based on a gradient.

8. The method of claim 1 wherein during said automatically generating the explanation, at least one selected from the group consisting of:
the non-anomalous tuple and the anomalous tuple have identical values for the plurality of features that are not the perturbed feature, and
a range of the perturbed value of the perturbed feature is not limited by an unperturbed value of the perturbed feature in the non-anomalous tuple.

9. The method of claim 1 further comprising initializing the perturbed value with one selected from the group consisting of: a random value and a predefined value.

10. The method of claim 1 wherein after said modifying the perturbed value, at least one selected from the group consisting of:
the reconstruction error of the perturbed feature is less than each respective reconstruction error of the plurality of features that are not the perturbed feature,
the reconstruction error of the perturbed feature is less than at least one respective reconstruction error of the plurality of features that are not the perturbed feature, and
the reconstruction error of the perturbed feature is less than an average respective reconstruction error of the plurality of features that are not the perturbed feature.

11. The method of claim 1 wherein:
the explanation identifies multiple features of the plurality of features as a cause of the anomalous tuple being anomalous;
the multiple features do not include the perturbed feature.

12. The method of claim 1 wherein at least one selected from the group consisting of:
the explanation allocates a fraction of attribution to a feature that is not the perturbed feature that is more than one selected from the group consisting of: fifty percent, seventy percent, and eighty percent;
the explanation allocates a fraction of attribution to the perturbed feature that is less than one selected from the group consisting of: twenty percent, ten percent, and five percent.

13. One or more non-transitory computer-readable media storing instructions that, when executed by one or more processors, cause:
generating, from a non-anomalous tuple, an anomalous tuple that contains a perturbed value of a perturbed feature of a plurality of features;
modifying, in the anomalous tuple, the perturbed value of the perturbed feature to cause a change in reconstruction error for the anomalous tuple, wherein the change in reconstruction error comprises at least one selected from the group consisting of:
a decrease in reconstruction error of the perturbed feature, and
an increase in a sum of reconstruction error of the plurality of features that are not the perturbed feature;
automatically generating, after said modifying the perturbed value, an explanation that identifies an identified feature of the plurality of features as a cause of the anomalous tuple being anomalous;
detecting whether the identified feature of the explanation is the perturbed feature.

14. The one or more non-transitory computer-readable media of claim 13 wherein said modifying the perturbed value is partly based on maximizing a quantity that is not a sum of reconstruction error of the plurality of features.

15. The one or more non-transitory computer-readable media of claim 13 wherein said modifying the perturbed value is partly based on minimizing reconstruction error of the perturbed feature.

16. The one or more non-transitory computer-readable media of claim 13 wherein:
said modifying the perturbed value is repeated in multiple iterations;
said modifying the perturbed value in an iteration comprises adjusting the perturbed value based on a multiplicative product that is based on a scaling factor;
the method further comprises decreasing the scaling factor for at least one iteration.

17. The one or more non-transitory computer-readable media of claim 16 wherein said decreasing the scaling factor is conditioned on at least one selected from the group consisting of:
a predefined count of iterations occurs since previously decreasing the scaling factor;
the respective reconstruction error of the perturbed feature is not less than the respective reconstruction error of the perturbed feature was when previously decreasing the scaling factor; and
a sum of respective reconstruction errors of the plurality of features that are not the perturbed feature is not less than a sum of respective reconstruction errors of the plurality of features that are not the perturbed feature when previously decreasing the scaling factor.

18. The one or more non-transitory computer-readable media of claim 13 wherein during said automatically generating the explanation, at least one selected from the group consisting of:
the non-anomalous tuple and the anomalous tuple have identical values for the plurality of features that are not the perturbed feature, and
a range of the perturbed value of the perturbed feature is not limited by an unperturbed value of the perturbed feature in the non-anomalous tuple.

19. The one or more non-transitory computer-readable media of claim 13 wherein the instructions further cause initializing the perturbed value with one selected from the group consisting of: a random value and a predefined value.

20. The one or more non-transitory computer-readable media of claim 13 wherein at least one selected from the group consisting of:
the explanation allocates a fraction of attribution to a feature that is not the perturbed feature that is more than one selected from the group consisting of: fifty percent, seventy percent, and eighty percent;
the explanation allocates a fraction of attribution to the perturbed feature that is less than one selected from the group consisting of: twenty percent, ten percent, and five percent.
